(19) United States
(12) Patent Application Publication
(10) Pub. No.: US 2022/0062808 A1
(43) Pub. Date: Mar. 3, 2022

(54) SEPARATOR AND CLEANER WITH SEPARATOR

(71) Applicant: SUZHOU GAMANA ELECTRIC APPLIANCE CO., LTD., Suzhou, Jiangsu (CN)

(72) Inventors: Jiawen Pan, Suzhou, Jiangsu (CN); Jingjing Zhang, Suzhou, Jiangsu (CN)

(21) Appl. No.: 17/415,720

(22) PCT Filed: Dec. 17, 2018
(86) PCT No.: PCT/CN2018/121610

§ 371 Date: Jun. 17, 2021

(51) Int. Cl. B01D 45/14; A47L 11/38; A47L 11/40

(52) U.S. Cl. CPC B01D 45/14; A47L 11/4027; A47L 11/38

(57) ABSTRACT

The present invention discloses a separator, including a top plate, a bottom plate, and a plurality of grid bars, wherein both the top plate and the bottom plate are circular in shape, and the diameter of the top plate is less than that of the bottom plate; the separator has a motor connection portion, and a center of the motor connection portion coincides with a rotation center of the separator; and the plurality of grid bars are circumferentially spaced between the top plate and the bottom plate. The present invention further discloses a cleaner with the above separator. The separator has large air inhaling force, and makes a drastic change to a speed of inhaled garbage. When the initial speed of the separator is low, it is not easy to inhale garbage. This improves a garbage separation effect without affecting the service life of a filter element.

### TECHNICAL FIELD

The present invention relates to the technical field of cleaners, and in particular, to a separator and a cleaner with the separator.

### BACKGROUND

A separator is a kind of device used for air-solid system separation or liquid-solid system separation. The working principle of the separator is that solid particles or liquid drops with larger inertial centrifugal force are scattered over an outer wall surface through rotational motion caused by a tangential introduction of an airflow. The separator is used in a cleaner to retain possible residual pollutants/dust in inhaled air before the air is discharged from the cleaner. Usually, the separator is non-rotatably mounted on a motor shaft of a motor of the cleaner and rotates at a high speed.

An existing separator generally includes a top plate and a bottom plate. Both the top plate and the bottom plate are circular in shape, and the diameter of the top plate is greater than that of the bottom plate. Such a separator has a small air inhaling force and makes a small change to a speed of an inhaled solid particle or liquid drop. When the initial speed of the separator is low, it is easy to inhale a solid particle or a liquid drop, resulting in a poor garbage separation effect. Moreover, the inhaled solid particle or liquid drop will adhere to a filter element, affecting the service life of the filter element.

### SUMMARY

An objective of the present invention is to provide a separator and a cleaner with the separator, to resolve the above technical problems in the prior art.

In order to achieve the above objective, the present invention adopts the following technical solutions:

According to an aspect, the present invention provides a separator, including a top plate, a bottom plate, and a plurality of grid bars, where both the top plate and the bottom plate are circular in shape, and the diameter of the top plate is less than that of the bottom plate;

the separator has a motor connection portion, and a center of the motor connection portion coincides with a rotation center of the separator; and

the plurality of grid bars are circumferentially spaced between the top plate and the bottom plate.

Preferably, a preset included angle is formed between the grid bar and the central axis of the separator, and the preset included angle is greater than 0 degrees and less than 90 degrees.

Preferably, a first through hole is disposed between the circumferentially-spaced grid bars.

Preferably, the top plate is provided with a plurality of second through holes, and the plurality of second through holes are circumferentially spaced around the motor connection portion.

According to another aspect, the present invention provides a cleaner with the above separator.

The separator and the cleaner with the separator that are provided in the present invention have the following beneficial effects:

The separator and the cleaner with the separator that are provided in the present invention have a large air inhaling force and make a drastic change to a speed of an inhaled solid particle or liquid drop. When the initial speed of the separator is low, it is not easy to inhale a solid particle or a liquid drop. This improves a garbage separation effect without affecting the service life of a filter element.

Additional aspects and advantages of the present invention are to be partially provided in the following description, and partially become evident in the following description, or understood through the practice of the present invention.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic three-dimensional (3D) structural diagram of a separator at one angle according to an embodiment of the present invention;

FIG. 2 is a schematic 3D structural diagram of a separator at another angle according to an embodiment of the present invention;

FIG. 3 is a front view of a separator according to an embodiment of the present invention; and

FIG. 4 is a sectional view in an A-A direction.

Reference numerals in the accompanying drawings: 1: top plate; 2: bottom plate; 3: grid bar; 4: motor connection portion; 5: first through hole; and 6: second through hole.

### DETAILED DESCRIPTION

To make the objectives, technical solutions, and advantages of the present invention clearer and more comprehensible, the present invention is described in further detail below with reference to specific embodiments and accompanying drawings. It should be understood that the description is exemplary and is not intended to limit the scope of the present invention.

In the description of the present invention, it should be understood that orientation or position relationships indicated by terms “upper”, “lower”, “top”, “bottom”, and the like are orientation or position relationships as shown in the drawings, and these terms are just used to facilitate description of the present invention and simplify the description, but not to indicate or imply that the mentioned apparatus or elements must have a specific orientation and must be constructed and operated in a specific orientation, and thus, these terms cannot be understood as a limitation to the present invention.

### Embodiment

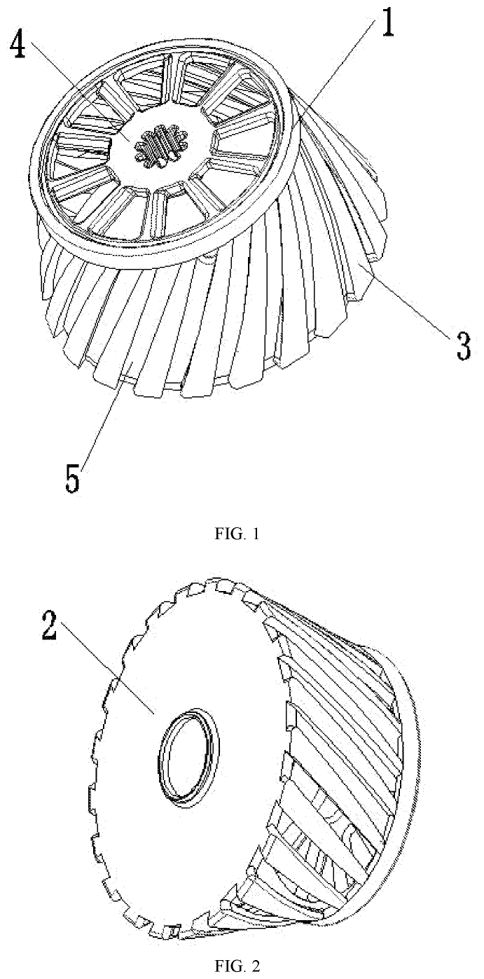

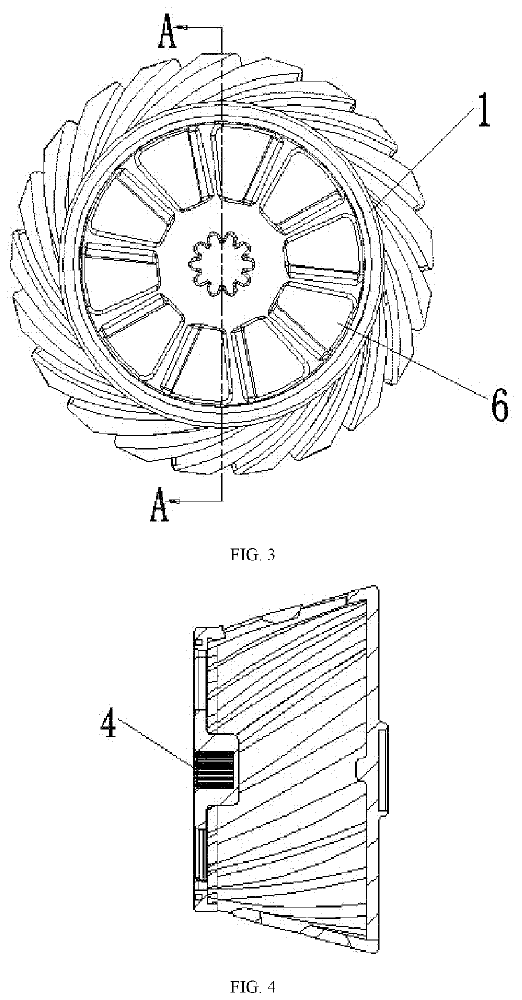

As shown in FIG. 1 to FIG. 4, this embodiment of the present invention provides a separator. The separator includes a top plate 1, a bottom plate 2, and a plurality of grid bars 3. Both the top plate 1 and the bottom plate 2 are circular in shape. The plurality of grid bars 3 are circumferentially spaced between the top plate 1 and the bottom plate 2. In a preferred implementation, the top plate 1, the bottom plate 2, and the grid bars 3 are made of plastic integrally.

In a preferred implementation, the separator has a motor connection portion 4, a center of the motor connection portion 4 coincides with the rotation center of the separator, and the separator is connected to an output shaft of a motor of a cleaner by using the motor connection portion 4.

In a preferred implementation, the grid bars 3 are the same, and a preset included angle is formed between the grid bar and the central axis of the separator. The preset included angle may be greater than 0 degrees and less than 90 degrees. A first through hole 5 is disposed between the circumferentially-spaced grid bars 3 to let air in.

In a preferred implementation, the top plate 1 is provided with a plurality of second through holes 6, and the plurality of second through holes 6 are circumferentially spaced around the motor connection portion 4 to let air out.

In a preferred implementation, the diameter of the top plate 1 is less than that of the bottom plate 2. In such a design manner, the separator has large air inhaling force, and makes a drastic change to a speed of an inhaled solid particle or liquid drop. When the initial speed of the separator is low, it is not easy to inhale a solid particle or a liquid drop. This improves a garbage separation effect without affecting the service life of a filter element.

In specific use, the separator scatters, over an outer wall surface through rotational motion caused by tangential introduction of an airflow, solid particles or liquid drops contained in air that is inhaled into a dust cup through an air inlet of the cleaner. In this way, the solid particles or liquid drops contained in the air are retained in the dust cup, and clean air flows into the separator through the first through hole 5, and is discharged from an air outlet of the cleaner through the second through hole 6.

The separator is used in a cleaner. Therefore, an embodiment of the present invention further provides a cleaner including the separator. A deducing process of a beneficial effect of the cleaner is similar to that of the beneficial effect of the separator. Details are not described herein again.

It should be understood that the above specific implementations of the present invention are only used to illustratively describe or explain the principle of the present invention, and do not constitute a limitation to the present invention. Therefore, any modifications, equivalent substitutions, and improvements made without departing from the spirit and scope of the present invention should be included in the protection scope of the present invention.

1. A separator, comprising a top plate (1), a bottom plate (2), and a plurality of grid bars (3), wherein both the top plate (1) and the bottom plate (2) are circular in shape, and the diameter of the top plate (1) is less than that of the bottom plate (2);
the separator has a motor connection portion (4), and a center of the motor connection portion (4) coincides with a rotation center of the separator; and
the plurality of grid bars (3) are circumferentially spaced between the top plate (1) and the bottom plate (2).

2. The separator according to claim 1, wherein a preset included angle is formed between the grid bar (3) and the central axis of the separator, and the preset included angle is greater than 0 degrees and less than 90 degrees.

3. The separator according to claim 1, wherein a first through hole (5) is disposed between the circumferentially-spaced grid bars (3).

4. The separator according to claim 1, wherein the top plate (1) is provided with a plurality of second through holes (6), and the plurality of second through holes (6) are circumferentially spaced around the motor connection portion (4).

5. A cleaner with a separator, wherein the separator is of claim 1.

6. A cleaner with a separator, wherein the separator is of claim 2.

7. A cleaner with a separator, wherein the separator is of claim 3.

8. A cleaner with a separator, wherein the separator is of claim 4.
